(19) United States
(12) Patent Application Publication
(10) Pub. No.: US 2016/0143714 A1
(43) Pub. Date: May 26, 2016

(54) METHOD FOR MAXILLARY SINUS FLOOR ELEVATION

(71) Applicants: Riccardo Favero, Motta Di Livenza (IT); Vittorio Favero, (US); Daniele Botticelli, Santarcangelo Di Romagna (IT); Luca Favero, Treviso (IT); Lorenzo Favero, Motta Di Livenza (IT)

(72) Inventors: Riccardo FAVERO, MOTTA DI LIVENZA (IT); Vittorio FAVERO, MOTTA DI LIVENZA (IT); Daniele BOTTICELLI, SANTARCANGELO DI ROMAGNA (IT); Luca FAVERO, TREVISO (IT); Lorenzo FAVERO, MOTTA DI LIVENZA (IT)

(21) Appl. No.: 14/548,963

(22) Filed: Nov. 20, 2014

(51) Int. Cl. A61C 8/00

(52) U.S. Cl. CPC A61C 8/0092

(57) ABSTRACT

Devices and methods for placement of a self-expanding stent into the elevated region of a sinus floor are described. A mucoperiosteal flap is first elevated along the edentulous ridge. A median osteotomy along the ridge is then performed by means of a vibrating sonic scalpel, up to the maxillary sinus floor. The Schneider membrane is subsequently elevated in order to allow the positioning of the stent. The stent is characterized by shape memory features and is made of nickel-titanium. Stent diameter is determined preoperatively by means of cone-beam CT. Stent length can be modified intraoperatively. The stent shifts back to the original shape keeping the Schneider membrane elevated with a minimally invasive approach and expanding the space available for neo-osteogenesis. The nickel-titanium mesh texture of the stent optimizes the contact surface between bone and clot, increasing the neo-osteogenic potential. As a consequence, a greater quantity and quality of the newly formed bone is obtained, minimizing invasivity and complications that affect current sinus lift techniques.

### FIELD

The present disclosure deals with a technique that can be used in dental implantology, in order to increase the vertical dimension of crestal bone elevating the Schneider membrane with a minimally invasive surgical approach and maximizing the quantity and quality of newly formed bone thanks to a completely biocompatible and inert Nitinol stent.

### DESCRIPTION OF RELATED ART

Maxillary sinus floor elevation was introduced by Tatum (1977, 1986) and further developed by Boyne & James (1980). This surgical procedure was aimed at augmenting the bone volume in the posterior segments of the maxilla and it has been widely propagated in clinical implant therapy. However, in the absence of grafting material (e.g. Xu et al. 2004), or of a device (Cricchio et al. 2009, 2011; Johansson et al. 2012; Schweikert et al. 2012), or of implants (Ellegaard et al. 1997, Lundgren et al. 2004; Palma et al. 2006; Cricchio et al. 2013) placed simultaneously at the time of sinus floor elevation, the maxillary sinus tended to regain its original shape and re-pneumatize (Xu et al. 2004).

Various grafting materials have been proposed for augmenting the space obtained after the elevation of the Schneiderian membrane. Autologous bone has been considered to represent the “gold standard” for grafting of maxillary sinus (for review see Klijn et al. 2010). Various studies have documented the resorptive aptitude of autologous bone, even though it may not only be resorbed, but may eventually be substituted by newly formed bone (John & Wenz 2004; Jensen et al. 2012; Lambert et al. 2011; Cosso et al. 2013; Scala et al. 2014). In contrast, bone substitutes, such as deproteinized bovine bone mineral, remain largely unchanged for long periods and, consequently, differences in resorption and shrinkage of the elevated regions may be expected when using autologous bone or bone substitutes (e.g. Xu et al. 2004).

Biomaterials have been frequently found embedded into connective tissue (e.g. Lambert et al. 2011), especially in the sub-Schneiderian membrane region (Tadjoedin et al. 2003), because such grafts do not resorb readily.

In order to maintain the space underneath an elevated sinus mucosa, the application of devices has been propagated (Johansson et al. 2010, Cricchio et al. 2009,2011).

In a clinical study (Johansson et al, 2010), spherical, hollow space-making devices made of hydroxyapatite were used within the void of the elevated sinus mucosa in three patients. Implants were installed after 6-9 months and loaded after additional 8 weeks. Neither implant loss nor marginal bone resorption was noticed after 1 year of loading. Biopsies harvested during implant site preparation revealed an integrity of the device and bone formation within the pores of the hydroxyapatite.

Resorbable polylactide devices were used in experiments in monkeys (Cricchio et al. 2009, 2011). Devices of different shapes were placed following the elevation of the sinus mucosa. Bone formation after 6 months of healing was a constant finding.

The use of a membrane to cover the antrostomy has been suggested by several authors that claimed that its absence may enhance the implant failure rate (Pjetursson et al. 2008; Tarnow et al. 2000) as well as the quantity of connective tissue formed within the subantral space obtained (Choi et al. 2009; Barone et al. 2013). However, some authors did not report differences in survival rate between antrostomies covered or not by membranes (Tones Garcia-Denche et al. 2013; Barone et al. 2013).

A transcrestal approach for sinus elevation was proposed with the use of osteotomes so that a cylindrical recipient site was prepared and, afterwards, the implants was installed (Summers 1994). This technique was further modified suggesting the transcrestal elevation with the preparation of an osteotomy shaped as a bony box prepared with a blade, that was subsequently elevated together the floor of the sinus. The void was fileld collagen sponges, added just before the implant was installed (Bruschi et al. 1998; Winter et al. 2002, 2003).

When the height of the base of the sinus is not sufficient to guarantee implant stability, the sinus floor has to be first elevated and implants may be installed after some months, when new bone is formed within the elevated region. However, during healing, a substantial shrinkage of the region has been described (e.g. Asai et al. 2002; Xu et al. 2004).

New predictable techniques are needed, that may maintain the space over time to allow bone formation preventing an extensive shrinkage of the sub-antral space created. Cylindrical nickel-titanium shape memory stents have become reliable techniques in the cardio-vascular field to maintain the patency of arteries and veins (for review see Bekken et al. 2014; Simard et al 2014).

### SUMMARY

The present disclosure discloses the use of a stent in maxillary sinus floor elevation.

According to one embodiment of the disclosure said stent has shape memory.

According to one embodiment of the disclosure said stent is self-expandable.

According to one embodiment of the disclosure said stent is cylinder shaped.

According to one embodiment of the disclosure said stent is made of TiNi.

According to one embodiment of the disclosure said stent is bio-absorbable.

According to one embodiment of the disclosure transcrestal maxillary sinus floor elevation using self-expandable stent is provided for.

According to one embodiment of the disclosure lateral maxillary sinus floor elevation using self-expandable stent is provided for.

The present disclosure also discloses a dental implant prosthetic rehabilitation comprising a first step of implant site preparation and a second step of installing the implant, the first step being a maxillary sinus floor elevation.

Advantageously the stent is so configured and located to create, after expansion, space available for neo osteogenesis and contact surface between bone and blood clot increasing neo osteogenic potential.

According to the first step, a crestal incision of the mucosa will be carried out and vestibular and palatal full thickness flaps will be elevated. After flap elevation, two parallel incisions will be performed in the center of the alveolar crest in a mesio-distal direction, at a distance <2.5 mm between them. The osteotomies will be made using a vibrating sonic handpiece (Sonosurgery® TKD Calenzano Fi, Italy) carrying a straight 0.25 mm thick micro saw (SFS 102 Komet Gebr. Brasseler-GMBH, Lemgo 32631 Germany) and exercising a minimal pressure, similar to that of a pencil when writing (about 2-3 N max).The osteotomes will be extended in a mesio-distal direction for the whole edentulous area to be treated. However, a safe distance of about 1.5 mm from the adjacent teeth will be maintained to avoid damages to the roots. The two parallel incisions will be connected by further bucco-lingual bone incisions performed at the mesial and distal ends of the two primary osteotomies.

A continuous movement, along the incisions, will be performed with the sonic insert, gradually penetrating into the bone, until a distinct change of material texture will be perceived, meaning that the base of the sinus has been reached. After that, using a surgical mallet on blunt chisels, the bony trapdoor will be released along the osteotomies with gentle shots.

Collagen sponges will be placed into the space obtained, to protect the Schneiderian mucosa from tearing, and subsequently pushed within the subantral space using the blunt chisels and mallet. The three-dimensional hydraulic pressure produced by the collagen soaked with blood favours the sinus membrane detachment from the bony walls. After sinus elevation, a cylindrical nickel-titanium shape memory stent of appropriate length and dimensions, as ascertained in the CBCT, will be placed into the elevated region. Subsequently, the device will be activated so that it will automatically return to its original dimensions, expanding within the elevated region. The flaps will be repositioned and sutured, allowing a primary intention wound closure.

A CBCT with low dosage will be taken immediately after the surgery.

As to second step, after 5 months from the first surgical session, full-thickness flaps will be elevated again and after recipient sites preparation, the implants will be installed.

There is also the possibility to use the stent as a space maintainer even in traditional sinus lift procedure with lateral access.

In summary, sinus floor elevation may be performed through a lateral or a transcrestal approach. When the height of the sinus floor is sufficient to guarantee the primary stability, implants may be installed immediately.

However, if sinus floor height is not sufficient, a two-stage approach should be applied. In this case, after the first surgery, a shrinkage of the elevated region may occur during healing if no not-resorbable fillers are placed within the elevated region. This shrinkage may jeopardize the stability of the implant at the second surgical stage. For this reason, a device that can stabilize the elevated region to allow a proper bone formation may be used.

The placement into the elevated region of a self-expanding stent represents a solution.

This technique contemplates first the elevation of a mucoperiosteal flap along the edentulous ridge. A median osteotomy along the ridge will be then performed by means of a vibrating sonic scalpel, up to the maxillary sinus floor. The Schneider membrane will subsequently be elevated in order to allow the positioning of the stent. The stent is characterized by shape memory features and it is made of nickel-titanium. The stent diameter is determined preoperatively by means of cone-beam CT. Its length can be modified intraoperatively. The stent will shift back to the original shape keeping the Schneider membrane elevated with a minimally-invasive approach and expanding the space available for neo-osteogenesis. The nickel-titanium mesh texture optimizes moreover the contact surface between bone and clot increasing the neo-osteogenic potential. The aim of our technique is to obtain grater quantity and quality of the newly formed bone minimizing invasivity and complications that affect current sinus lift techniques. 5 months after the procedure it will be possible to proceed with the traditional steps of implant and prosthetic rehabilitation.

### BRIEF DESCRIPTION OF DRAWINGS

FIG. 1 is a simplified, front view illustration of a human face, showing the position of the maxillary sinus;

FIG. 2 is a simplified occlusal jaw view with distal edentulia, and a crestal incision of the mucosa by means of a scalpel;

FIG. 3 is a simplified occlusal jaw view where full thickness flaps are elevated and the bone is exposed;

FIG. 4 is a simplified, sectional illustration of the maxillary sinus, lateral maxillary walls, antral floor, schneiderian membrane and reflected mucoperiosteal flap, we can also see a vibrating sonic handpiece performing the osteotomy;

FIG. 5 is a simplified occlusal jaw view with distal edentulia and the performed osteotomy;

FIG. 6 is a simplified, sectional illustration of the maxillary sinus, lateral maxillary walls, antral floor, schneiderian membrane and reflected mucoperiosteal flap, we can also see the blunt chisels detaching the sinus membrane from the bony walls;

FIG. 7 is a simplified, sectional illustration of the maxillary sinus, lateral maxillary walls, antral floor, schneiderian membrane and reflected mucoperiosteal flap, we can also see the placement of the cylindrical nickel-titanium shape memory stent of appropriate length and dimensions into the elevated region;

FIG. 8 is a simplified, sectional illustration of the maxillary sinus, lateral maxillary walls, antral floor, schneiderian membrane and reflected mucoperiosteal flap; we can also see the activation of the nichel-titanium stent automatically returned to its original dimensions, expanding within the elevated region;

FIG. 9 is a simplified, sectional illustration of the maxillary sinus, lateral maxillary walls, antral floor, elevated schneiderian membrane; we can also see the new-formed bone with the osteointegrated stent;

FIG. 10 is a simplified, sagittal view of the maxillary sinus, lateral maxillary walls, and schneiderian membrane; we can also see the expanded nichel-titanium stent elevating the schneiderian membrane;

FIG. 11 is a simplified, sagittal view of the maxillary sinus, lateral maxillary walls, with the new-formed bone and the traditional implant rehabilitation of the patient.

### DETAILED DESCRIPTION

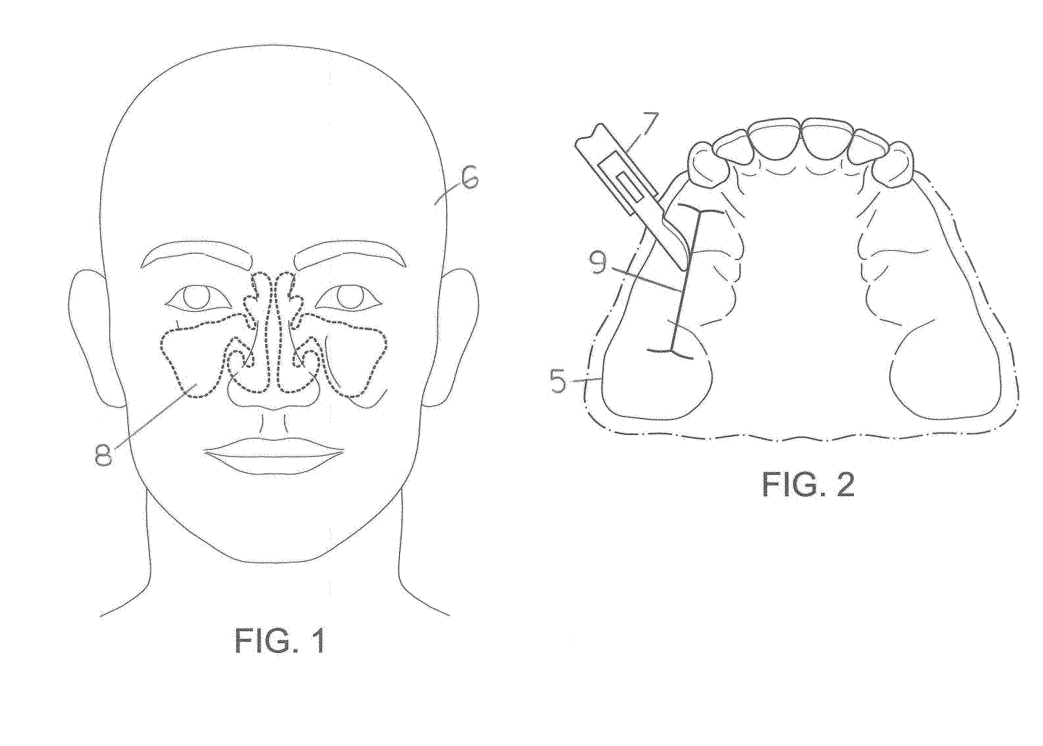

Anatomy of the maxillary sinus region will now be briefly described with reference to FIG. 1. FIG. 1 is a simplified, front view illustration of a human face 6, showing the position of the maxillary sinus 8.

FIG. 2 is a simplified occlusal view of the jaw 5 with distal edentulia, and a scalpel 7 A crestal incision of the mucosa 9 will be carried out.

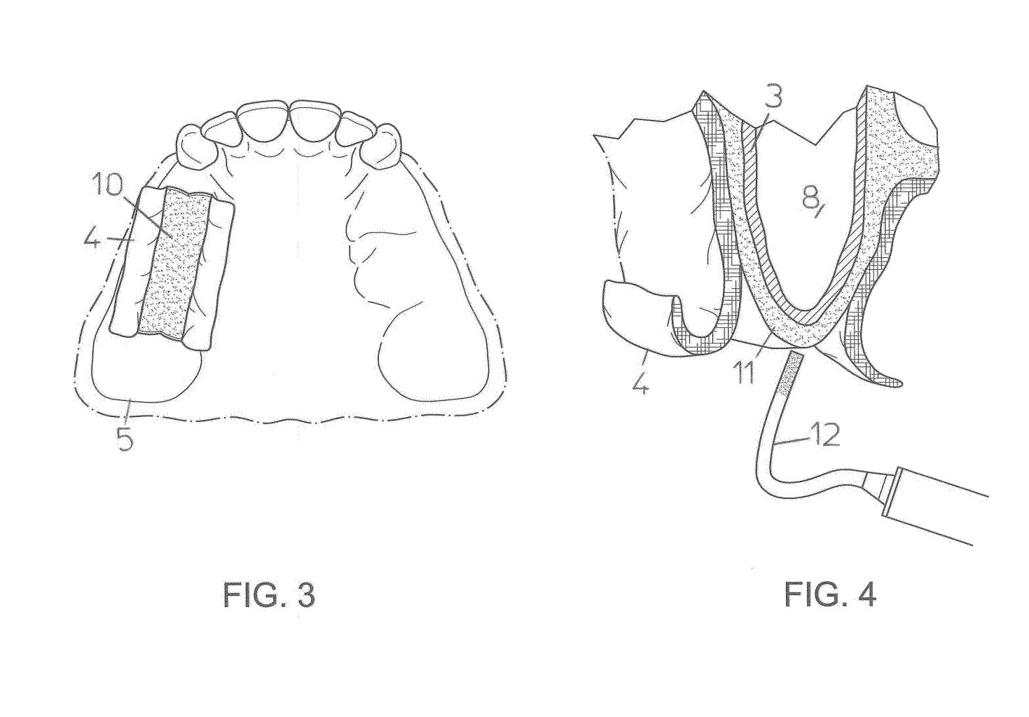

FIG. 3 is a simplified occlusal jaw 5 view, vestibular and palatal full thickness flaps 4 will be elevated and the bone is exposed 10.

FIG. 4 is a simplified, sectional illustration of the maxillary sinus 8, lateral maxillary walls 11, schneiderian membrane 3 and reflected mucoperiosteal flaps 4, The osteotomies will be performed by the use of a vibrating sonic handpiece 12 (Sonosurgery® TKD Calenzano Fi, Italy) carrying a straight 0.25 mm thick micro saw (SFS 102 Komet Gebr. Brasseler-GMBH, Lemgo 32631 Germany) and exercising a minimal pressure, similar to that of a pencil when writing (about 2-3 N max).

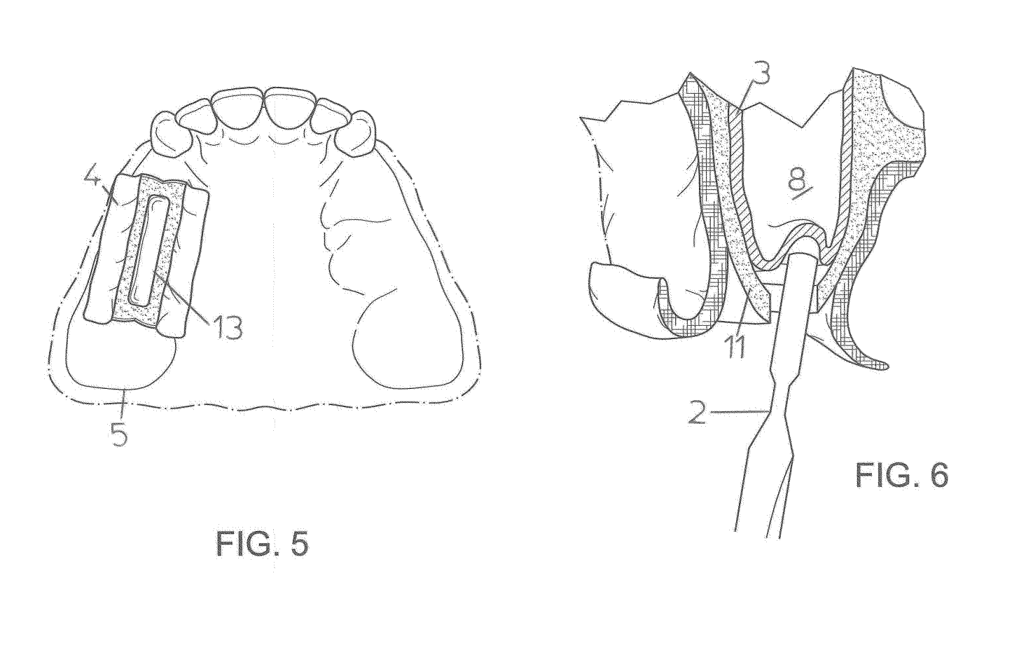

FIG. 5 is a simplified occlusal jaw 5 view with distal edentulia, reflected mucoperiosteal flaps 4, two parallel incisions will be performed in the center of the alveolar crest in a mesio-distal direction, at a distance <2.5 mm between them. The osteotomies 13 will be extended in a mesio-distal direction for the whole edentulous area to be treated. However, a safe distance of about 1.5 mm from the adjacent teeth will be maintained to avoid damages to the roots. The two parallel incisions will be connected by further bucco-lingual bone incisions performed at the mesial and distal ends of the two primary osteotomies. A continuous movement, along the incisions, will be performed with the sonic insert, gradually penetrating into the bone, until a distinct change of material texture will be perceived, meaning that the base of the sinus has been reached.

FIG. 6 is a simplified, sectional illustration of the maxillary sinus 8, lateral maxillary walls 11, schneiderian membrane 3 and reflected mucoperiosteal flaps 4, using a surgical mallet on blunt chisels 2, the bony trapdoor will be released along the osteotomies with gentle shots. Collagen sponges will be placed into the space obtained, to protect the Schneiderian mucosa from tearing, and subsequently pushed within the subantral space using the blunt chisels and mallet. The three-dimensional hydraulic pressure produced by the collagen soaked with blood favor the sinus membrane detachment from the bony walls.

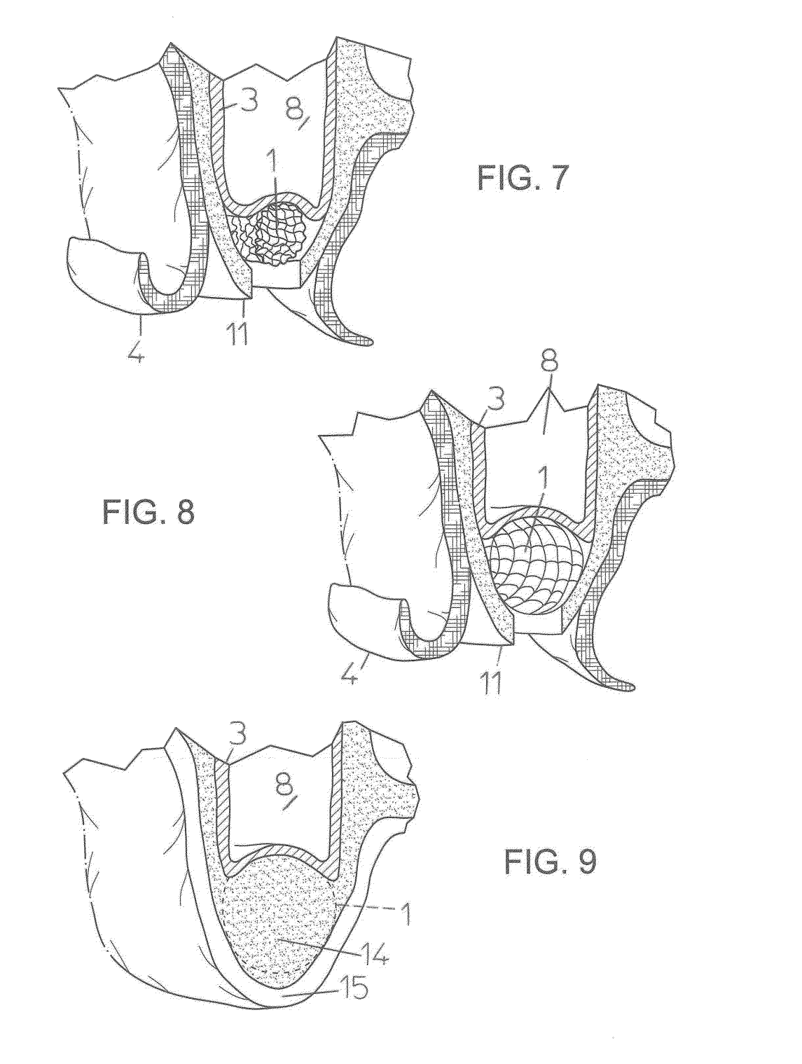

FIG. 7 is a simplified, sectional illustration of the maxillary sinus 8, lateral maxillary walls 11, schneiderian membrane 3 and reflected mucoperiosteal flaps 4; after sinus elevation, a cylindrical nickel-titanium shape memory stent 1 of appropriate length and dimensions, as ascertained in the CBCT, will be placed into the elevated region.

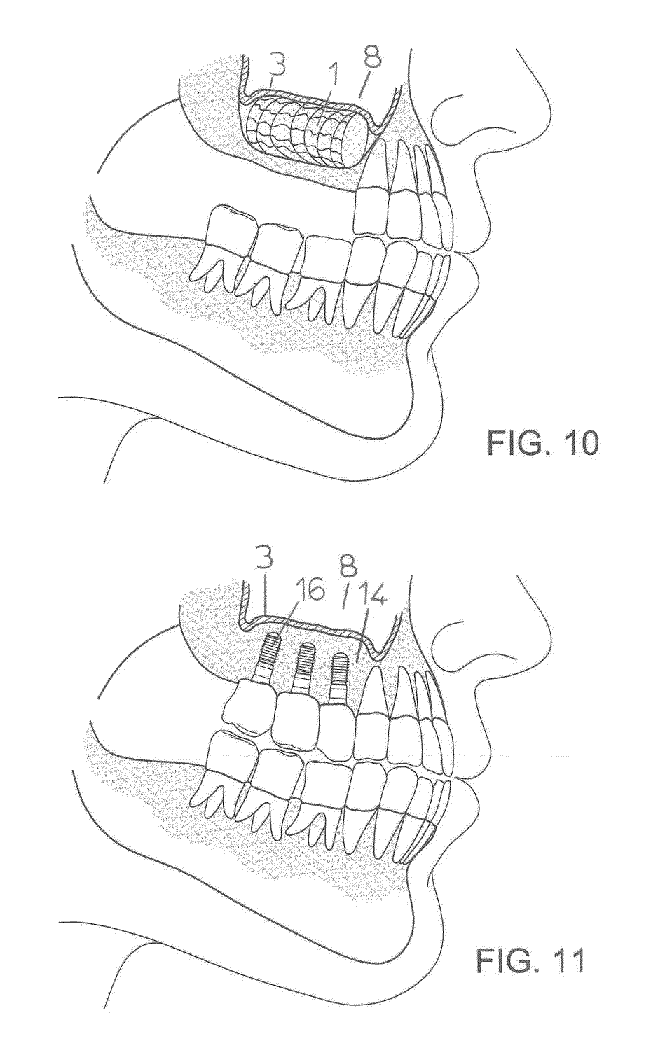

FIG. 8 is a simplified, sectional illustration of the maxillary sinus 8, lateral maxillary walls 11, schneiderian membrane 3 and reflected mucoperiosteal flaps 4, Subsequently, the stent 1 will be activated so that it will automatically return to its original dimensions, expanding within the elevated region. FIG. 9 is a simplified, sectional illustration of the maxillary sinus 8, elevated schneiderian membrane 3, we can also see the new-formed bone 14 with the osteointegrated stent 1 The flaps were repositioned using a primary intention wound closure 15. FIG. 10 is a simplified, sagittal view of the maxillary sinus 8, and schneiderian membrane 3, we can also see the expanded nickel-titanium stent 1 elevating the schneiderian membrane. FIG. 11 is a simplified, sagittal view of the maxillary sinus 8 and schneiderian membrane 3, we can see the new-formed bone 14 after five months from the first surgical session and the traditional implant-prosthetic rehabilitation 16.

It will be appreciated by persons skilled in the art that the present invention is not limited to what has been particularly shown and described hereinabove. Rather, the scope of the present invention is defined only by the claims that follow.

1. A method comprising:
providing a stent; and
using the stent in maxillary sinus floor elevation.

2. The method of claim 1, wherein said stent has shape memory.

3. The method of claim 1, wherein said stent is self-expandable.

4. The method of claim 1, wherein said stent is cylinder-shaped.

5. The method claim 1, wherein said stent is made of TiNi.

6. The method claim 1, wherein said stent is bio-absorbable.

7. A method comprising:
providing a self-expandable stent; and
using the self-expandable stent in a transcrestal maxillary sinus floor elevation procedure or lateral maxillary sinus floor elevation procedure.

8. A dental implant prosthetic rehabilitation process comprising:
a first step of implant site preparation and
a second step of installing the implant,
wherein said first step comprises maxillary sinus floor elevation using a self-expanding stent.

9. The dental implant prosthetic rehabilitation process according to claim 8, wherein the stent is so configured and located to create, after expansion, space available for neo-osteogenesis and contact surface between bone and blood clot increasing neo-osteogenic potential.
